(19) United States
(12) Patent Application Publication
(10) Pub. No.: US 2024/0382884 A1
(43) Pub. Date: Nov. 21, 2024

(54) MODULAR FILTER MEDIA ARRANGEMENTS

(71) Applicant: Cummins Filtration Inc., Nashville, TN (US)

(72) Inventors: Gregory K. Loken, Stoughton, WI (US); Jessie A. Knight, Oregon, WI (US); Daniel Potratz, Stoughton, WI (US)

(73) Assignee: Cummins Filtration Inc., Nashville, TN (US)

(21) Appl. No.: 18/692,659

(22) PCT Filed: Sep. 13, 2022
(86) PCT No.: PCT/US2022/043328

§ 371 Date: Mar. 15, 2024

Related U.S. Application Data
(60) Provisional application No. 63/245,257, filed on Sep. 17, 2021.

(51) Int. Cl. B01D 46/00; B01D 46/62; B01D 53/92

(52) U.S. Cl. CPC B01D 46/0005; B01D 46/0013; B01D 46/62; B01D 53/92; B01D 2265/06

(57) ABSTRACT

A filter element includes a frame and a media pack coupled to the frame. The frame includes a base, a plurality of receptacles extending across the base, and a keyway disposed in between two receptacles of the plurality of receptacles. The key way is structured to facilitate alignment between the filter element and a filter housing. The media pack includes a plurality of media modules each coupled to a respective one of the plurality of receptacles.

### CROSS-REFERENCE TO RELATED PATENT APPLICATIONS

The present application is a National Phase Application based on PCT/US2022/043328, filed Sep. 13, 2022, which claims the benefit of and priority to U.S. Provisional Patent Application No. 63/245,257, filed Sep. 17, 2021. The contents of these applications are incorporated by reference in their entirety.

### TECHNICAL FIELD

The present disclosure relates generally to filters for use with internal combustion engine systems.

### BACKGROUND

Internal combustion engines generally use various fluids during operation. These fluids may become contaminated with particulate matter (e.g., carbon, dust, metal particles, etc.) which may damage the various parts of the engine if not removed from the fluid. To remove such particulate matter and/or other contaminants, the fluid is generally passed through a filter assembly (e.g., an air filter, a fuel filter, a lubricant filter, a water filter assembly, etc.) structured to clean the fluid.

### SUMMARY

At least one embodiment relates a filter element. The filter element includes a frame and a media pack coupled to the frame. The frame includes a base, a plurality of receptacles extending across the base, and a keyway disposed in between two receptacles of the plurality of receptacles. The keyway is structured to facilitate alignment between the filter element and a filter housing. The media pack includes a plurality of media modules each coupled to a respective one of the plurality of receptacles.

Another embodiment relates to a filter assembly. The filter assembly includes a housing defining an interior cavity and a filter element disposed at least partially within the interior cavity. The housing includes at least one interior wall extending into the interior cavity. The filter element includes a media pack and a frame coupled to the media pack. The media pack includes a plurality of media modules. The frame includes a keyway disposed in between two media modules of the plurality of media modules. The interior wall extends into the keyway.

Yet another embodiment relates to a frame for a filter element. The frame includes a base, a plurality of receptacles extending across the base, and a keyway. Each receptacle of the plurality of receptacles is sized to receive a media module therein. Each receptacle of the plurality of receptacles defines an opening that extends through the base. The keyway is disposed adjacent to at least one of the plurality of receptacles. The keyway is configured to engage an interior wall of a filter housing to facilitate alignment between the filter element and the filter housing. The keyway includes a first wall that extends axially away from the base.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a side cross-sectional view of a filter assembly, according to an embodiment.

FIG. 2 is an exploded view of the filter assembly of FIG. 1.

FIG. 3 is a top perspective view of a filter element of the filter assembly of FIG. 1.

FIG. 4 is a top perspective view of a media pack and frame subassembly of the filter assembly of FIG. 3,

FIG. 5 is a side cross-sectional view of the subassembly of FIG. 4.

FIG. 6 is a perspective view of a media module for a filter element, according to an embodiment.

FIG. 7 is a top view of the media module of FIG. 6.

FIG. 8 is a perspective view of an unwound media module for a filter element, according to an embodiment.

FIG. 9 is a top perspective view of a media pack for a filter assembly, according to an embodiment.

FIG. 10 is a top perspective view of a media pack for a filter assembly, according to another embodiment.

FIG. 11 is a top perspective view of a media pack for a filter assembly, according to yet another embodiment.

FIG. 12 is a top perspective view of a media pack and frame subassembly, according to an embodiment.

FIG. 13 is a top perspective view of a media pack and frame subassembly, according to another embodiment.

FIG. 14 is a top perspective view of a media pack and frame subassembly, according to yet another embodiment.

FIG. 15 is a top perspective view of a media pack and frame subassembly formed from substantially rectangular media modules, according to an embodiment.

FIG. 16 is a top perspective view of a media pack and frame subassembly formed from substantially rectangular media modules, according to another embodiment.

FIG. 17 is a top perspective view of a filter element, according to another embodiment,

FIG. 18 is a top view of the filter element of FIG. 17.

FIG. 19 is a top perspective view of a filter element, according to another embodiment.

FIG. 20 is a top view of the filter element of FIG. 19.

FIG. 21 is a top perspective view of a filter element, according to another embodiment.

FIG. 22 is a side view of the filter element of FIG. 21.

FIG. 23 is a top perspective view of a filter element, according to another embodiment.

FIG. 24 is a side cross-sectional view of a filter assembly including the filter element of FIG. 23.

FIG. 25 is an exploded view of the filter assembly of FIG. 24.

FIG. 26 is a top perspective view of a filter element, according to yet another embodiment.

FIG. 27 is a side cross-sectional view of a filter assembly including the filter element of FIG. 26.

FIG. 28 is an exploded view of the filter assembly of FIG. 27.

FIG. 29 is a top perspective view of a filter element, according to yet another embodiment.

FIG. 30 is a side cross-sectional view of a filter assembly including the filter element of FIG. 29.

FIG. 31 is an exploded view of the filter assembly of FIG. 30.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to filter assemblies including filter elements made from multiple filter media modules. The various concepts introduced above and discussed in greater detail below may be implemented in any of numerous ways, as the described concepts are not limited to any particular manner of implementation. Examples of specific implementations and applications are provided primarily for illustrative purposes.

### 1. Overview

Filter assemblies are used in internal combustion engine systems to remove particulate contamination from a working fluid (e.g., air, lube oil, fuel, etc.). A filter assembly for an air filtration application may include a filter housing and a replaceable filter element that is contained within the housing. The housing may direct air through the filter element, which filters the air and removes contaminants from the incoming air stream. The performance requirements (e.g., flow rate, pressure drop, etc.) and available packaging space for the filter assembly will depend on the end-user requirements, and the filter assembly may need to be customized to meet the needs of a specific customer and/or application. Generally, this process involves resizing a standard filter assembly and filter element based on client specifications. For example, a filter assembly having a circular filter element geometry (e.g., a media pack having a circular cross-sectional shape) and requiring as much flow area as possible would be resized to fit within the largest available circular space in the client's application. However, because space constraints are rarely perfectly circular or rectangular, this customization process may result in wasted space and reduced performance of the customized filter assembly. Additionally, the customer may desire to prevent the use of non-genuine filter elements in the filter assembly, which may be of lesser quality than the genuine filter element and can lead to damage of the internal combustion engine system.

In contrast to the foregoing filter element designs, at least one implementation described herein relates to a filter element having a media pack that includes multiple individual media modules. The media modules may be designed in a first shape (e.g., cylindrical, rectangular, etc.) and may be arranged together to form a second shape for the combined media pack that is the same as or different from the first shape. For example, at least one media module may include multiple media layers that are spiral wound into a cylindrical shape. The media modules may then be coupled to a frame in an array to form any desired media pack geometry (e.g., a media pack having a rectangular cross-sectional shape with curved ends, a trapezoid, etc.). In another embodiment, at least one media module may include multiple filtration sheets that are layered into rectangular blocks. In some embodiments, at least one of the media modules may be sized differently from the other media modules, to accommodate variations in available packaging space in three dimensions, and to increase the Overall media volume within the media pack. In contrast to existing filter element designs, using multiple individual media modules to form the media pack allows the shape of the filter element to be modified to match the available packaging space in different applications. The media modules may also be formed using a single process and common tooling. For example, each media module may be formed from a single continuous media form that is cut and rolled to form the individual modules.

The media modules may each include a tetrahedral media geometry and may be produced from multiple layered sheets of filter media. In particular, the media modules may each include a flat sheet (e.g., an unformed sheet, a sheet without bend lines, etc.) and a formed tetrahedral sheet (e.g., a sheet that includes bend lines, etc.) coupled to the flat sheet. The layered sheets may be spiral wound, stacked repeatedly along a single direction, or otherwise formed into a variety of different shapes (e.g., first shapes) which, advantageously, provides an additional degree of freedom when customizing the shape of the media pack. The formed tetrahedral sheet may include combined media forms that are configured to allow for cross-flow between the flat and formed sheets (e.g., flow moving both parallel to the forms and between adjacent forms). In air filter implementations, this cross-flow may allow for more even dust loading on the upstream side of the media, thereby increasing the overall filter capacity as compared to other media geometries. In other words, a tetrahedral media geometry can provide a larger degree of dimensional freedom in the design of the multiple module media pack and flexibility in the spacing between adjacent media modules without sacrificing filter performance.

In at least one embodiment, the media pack may include a blank (e.g., void, unused area, cavity, space, etc.) that at least partially forms a keyway of the filter element. The keyway may further comprise a depression in the filter element and/or filter element frame (e.g., a conical depression, recessed area, void space, etc.). In an example embodiment, the blank is sized consistent with a volume of least one media module. In other words, the keyway may be at least partially formed as a blank in the media pack along the rows and/or columns of media modules. The keyway may be engageable with an interior wall of the housing to facilitate alignment between the filter element and the filter housing and/or to prevent the use of non-genuine filter elements in the filter housing. The keyway may also provide an area for handles, fittings, and/or other features that facilitate manipulation and replacement of the filter element, without substantially changing the performance of the filter element (e.g., without increasing pressure drop, etc.).

Alternatively or in combination, the keyway may be used as an inlet or outlet for the filter element. For example, the keyway may form a conduit that guides dirty air to an upstream end of each individual media module. Flow then passes through the media modules and out through a downstream end of the media modules on the same side of the filter element as the inlet. In such an implementation, the inlet and the outlet of the filter element may be located along the same plane which, beneficially, accommodates applications where air flow must be directed into and out of the filter assembly from the same side of the filter housing.

As used herein, the term “filter element” refers to a structure includes a media pack and supporting elements (e.g., frame, endcaps, seals, etc.) that physically connect the media pack to the filter housing. The term “media pack” refers to a portion of the filter element that is configured to remove particulate contaminants from a fluid passing through the filter element. The term “media module” refers to one of a plurality of formed structures that are arranged in an array along the supporting elements to form the media pack. The media modules may be substantial duplicates of one another, or may vary in size and shape. Each media module may have a dirty, upstream end, and a clean, downstream end. The term “combined media form” refers to a joined layering of materials (e.g., sheets of media, structural materials, etc.) that may be folded, stacked, or otherwise altered into a desired shape to form a media module. Finally, the term “filter media” may be used to describe, generally, material used to form the combined media form, media modules, and media pack.

### I. Example Filter Assembly

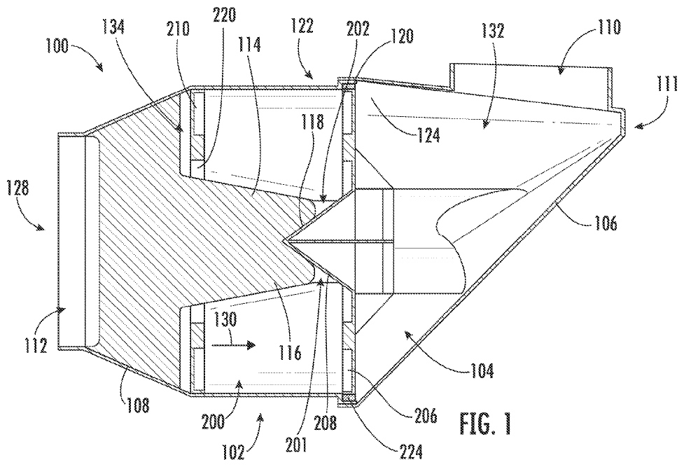

FIG. 1 is a side cross-sectional view of a filter assembly 100, according to an example embodiment. The filter assembly 100 may be an air filter assembly (e.g., air cleaner, etc.) for an internal combustion engine system that is structured to remove particulate matter from dirty air entering the internal combustion engine system. The filter assembly 100 includes a housing 102 and a filter element 200 sealingly engaged with the housing 102. The housing 102 forms an interior cavity 104 (e.g., an internal cavity, hollow portion, etc.) that is sized to receive the filter element 200 therein. Although the filter element 200 is described with reference to an air filter assembly for an internal combustion engine system, it should be appreciated that filter elements of similar design may be used in other systems, such as for lube oil, fuel, and water filtration in various other applications.

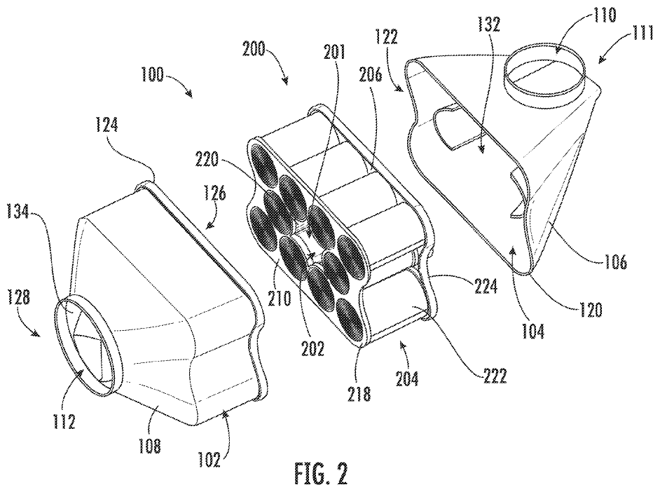

As shown in FIGS. 1-2, the filter element 200 may be removable from the housing 102 for replacement when the filter element 200 becomes clogged and/or when the pressure drop across the filter element 200 satisfies a pressure drop threshold (e.g., exceeds a threshold value, etc.). The housing 102 is configured to direct air through the filter element 200, and from the filter element 200 toward other parts of the filtration system and/or internal combustion engine system. The housing 102 includes a multi-piece body that includes a first portion 106 (e.g., a first body, an inlet portion, etc.) and a second portion 108 (e.g., a second body, an outlet portion, etc.) detachably coupled to the first portion 106. The first portion 106 may define a first opening 110 (e.g., an inlet opening at an inlet connection) proximate a first end 111 of the first portion 106 and a second opening 120 (e.g., first filter element opening) at a second end 122 of the first portion 106 that is sized to accommodate at least part of the filter element 200. The second portion 108 may define a third opening 124 (e.g., a second filter element opening) at a first end 126 of the second portion 108 that is sized to accommodate at least part of the filter element 200 and a fourth opening 112 (e.g., at an outlet connection) at a second end 128 of the second portion 108. As shown in FIGS. 1-2, the first portion 106 and the second portion 108 are coupled to one another along a plane that is oriented substantially normal to an airflow direction through the housing 102. The first portion 106 may be coupled to the second portion 108 via clips, latches, or another suitable fastener.

The filter assembly 100 may be structured to facilitate installation of the filter element 200 into the housing 102. As shown in FIG. 1, the housing 102 may include an interior wall 114 structured to engage with a keyway 202 of the filter element 200. The interior wall 114 and keyway may help guide the filter element 200 into the second portion 108 during assembly. The interior wall 114 may be coupled to and/or form part of an interior surface of the second portion 108. The interior wall 114 may extend along a flow direction 130 toward the keyway 202. The keyway 202 may comprise a blank (e.g., void, unused area, cavity, space, etc.) in the media pack 204 of the filter element 200 that is sized to receive the interior wall 114 therein. As shown in FIG. 1, the interior wall 114 may include a first conical protrusion 116 having a decreasing diameter along the flow direction 130 so as to facilitate positioning of the filter element 200 and to guide the filter element 200 into position within the second portion 108. In some embodiments, a cross-sectional shape of the first conical protrusion 116 may correspond to (e.g., may be the same as or substantially similar to) a cross-sectional shape of the keyway 202. For example, both the first conical protrusion 116 and the keyway 202 may have a circular cross-sectional shape, a multi-point star cross-sectional shape, or any other suitable shape.

As shown in FIG. 1, the keyway 202 may be at least partially formed by a frame, shown as first frame 206, of the filter element 200. For example, the first frame 206 may include a frame wall 208 that extends axially into a blank 201 in the media pack 204 from an opposing axial end of the blank 201 as the interior wall 114 (e.g., a frame wall 208 that extends axially into the keyway 202). The frame wall 208 may protrude axially beyond a plurality of receptacles 216 in the first frame 206 that are sized to receive a plurality of media modules therein. In the embodiment of FIG. 1, the frame wall 208 is a second conical protrusion that extends into a recessed area 118 defined by the interior wall 114 at an outer end (e.g., an axial end, etc.) of the interior wall 114. The recessed area 118 may have a shape that is complementary to a shape of the second conical protrusion. The tapered shape of the second conical protrusion and recessed area 118 can facilitate alignment (e.g., centering) of the filter element 200 with respect to the second portion 108 during installation.

### II. Example Filter Elements

Referring now to FIG. 3, a perspective view of a filter element is shown, which may be the same as or similar to the filter element 200. For convenience, the same numbering will be used to identify similar components. The filter element 200 includes frames (e.g., frame members, end plates, end caps, etc.), including a first frame 206 and a second frame 210; and a media pack 204 disposed between the first frame 206 and the second frame 210. The first frame 206 and the second frame 210 are disposed at opposing axial ends of the media pack 204. The media pack 204 may be sealingly coupled to the first frame 206 and/or the second frame 210 to prevent leakage around axial ends of the media pack 204.

As shown in FIG. 3, the first frame 206 and/or the second frame 210 may include a base 214 and a plurality of receptacles 216 (e.g., recessed areas, etc.) extending in at least one row across the base 214. Each one of the plurality of receptacles 216 may include a perimeter wall 219 forming an enclosed shape that extends axially away from the base 214. In the embodiment of FIG. 3, three rows of receptacles 216 are arranged along the base 214, with a center row (in between two outer rows) being offset from the outer rows. Beneficially, the offset/staggered arrangement between rows can increase the overall media area that can be accommodated within the space of the first frame 206 or the second frame 210. The offset can also ensure consistent spacing between adjacent ones of the plurality of receptacles 216 along each row and in between rows. In other example embodiments, the number and/or position the plurality of receptacles 216 may be different. As shown in FIG. 3, each receptacle of the plurality of receptacles 216 may include a cylindrically-shaped wall extending away from the base 214 in a substantially perpendicular orientation with respect to the base 214 and defining a plurality of recessed areas 215 along the base 214. Each receptacle also includes a through-hole opening 218 that extends through the base 214 and that fluidly couples the media pack 204 to one of the first portion 106 or the second portion 108 (see FIG. 2). In other embodiments, the shape of at least one of the plurality of receptacles 216 may be different. For example, at least one of the plurality of receptacles 216 may be an oval shape, an elliptical shape, or another suitable shape.

As shown in FIG. 2, the second frame 210 may be substantially similar to the first frame 206 and may include the same features as the first frame 206. The second frame 210 may also define an opening, shown as a keyway opening 220, disposed at a central position along the base 214, in between two receptacles of the plurality of receptacles 216. In particular, the position of the keyway opening 220 may correspond with (e.g., is the same as) a position of a blank (e.g., the blank 201) in the media pack that is sized consistent with a single media module (e.g., sized greater than or equal to a volume of a single media module 222), as will be further described. The keyway opening 220 may be fluidly coupled to a space in between the first frame 206 and the second frame 210.

In the example embodiment of FIGS. 1-3, the keyway opening 220 is sized to receive the interior wall 114 of the second portion 108 therein to facilitate alignment between the filter element 200 and the second portion 108 during assembly. However, it will be appreciated that the keyway opening 220 may function differently in other embodiments. For example, the keyway opening 220 (and the keyway 202) may define an inlet opening and/or an outlet opening for the filter element 200 (an opening that is fluidly coupled to a first axial end of the filter element 200), in which case the second portion 108 of the housing 102 may define both the inlet and the outlet of the filter assembly. In such an implementation, the keyway opening 220 (and the keyway 202) may extend through the base 214 and may fluidly couple a first cavity 132 of the first portion 106 to a second cavity 134 of the second portion 108 (e.g., the keyway opening 220 may form part of a fluid conduit extending through the filter element 200 between the first cavity 132 and the second cavity). Alternatively, the first frame 206 may additionally include or define a recessed area or fluid plenum structured to fluidly couple the keyway opening 220 (and the keyway 202) to a first axial end of the media pack 204 (e.g., an upstream end, an end closer to the first portion 106 than the second portion 108, etc.). In at least one embodiment, the second portion 108 includes a fluid conduit that extends through at least a portion of the filter element 200 and toward the keyway opening 220. The fluid conduit may be sealingly engaged with the keyway opening 220 (e.g., the second frame 210) and/or to the first frame 206 to fluidly couple the keyway opening 220 to the intet of the filter assembly 100 (e.g., the inlet at a first axial end of the filter element 200).

The interior cavity 104 at the second portion 108 (e.g., the second cavity 134) may fluidly couple openings in the second frame 210 (e.g., a second axial end of the media pack 204) to an outlet of the filter assembly 100 (an outlet that is also defined by the second portion 108). In such an implementation, the inlet and the outlet of the filter element 200 are both located along the same plane (e.g., a reference plane 217 as shown in FIG. 3 that extends parallel to the base 214 of the second frame 210). In other embodiments, the flow through the filter assembly 100 may be reversed (e.g., the keyway opening 220 may form an outlet opening of the filter element 200).

As shown in FIGS. 2-3, the first frame 206 and the second frame 210 may be oriented substantially perpendicular to an airflow direction (e.g., the flow direction 130) through the housing when the filter element 200 is installed in the housing. The filter element 200 may include a sealing member 224 (e.g., gasket, O-ring) coupled to the first frame 206 and structured to sealingly engage the filter element 200 with the second portion 108. The sealing member 224 may be disposed along an outer perimeter of the first frame 206 and may face radially away from the first frame 206 (so as to form a radial seal against an inner surface of the second portion 108). In other embodiments, the position of the sealing member 224 may be different (e.g., the sealing member 224 may be disposed on the second frame 210, the sealing member 224 may be an axially facing scaling member configured to sealingly engage with an axially-facing surface of the second portion, etc.). The sealing member 224 may be press-fit onto the first frame 206, glued to the first frame 206 using a suitable adhesive, overmolded onto the first frame 206, or otherwise coupled thereto.

As shown in FIG. 3, the first frame 206 may also define a handle 226 that facilitates manual manipulation of the filter element 200 (e.g., installation or removal). The handle 226 may be disposed at the keyway 202 and may extend axially away from the base 214, The handle 226 may also be structured to engage with an interior wall of the first portion 106 to facilitate assembly of the first portion 106 to the filter element 200 and second portion 108. The first frame 206 may also define the second conical protrusion (e.g., frame wall 208) that extends into the blank 201 between adjacent media modules and toward the keyway opening 220 (see FIG. 2).

In an example embodiment, a shape of the first frame 206 is the same as or substantially similar to a shape of the second frame 210. As shown in FIG. 3, both the first frame 206 and the second frame 210 may have a non-circular and/or non-rectangular cross-sectional shape, so that an outer perimeter of the first frame 206 and/or the second frame 210 is not in the shape of a circle or a rectangle. For example, an outer perimeter of the first frame 206 and the second frame 210 may have two straight sides 228 oriented parallel to one another on opposing ends of the frame and two at least partially curved sides 230 oriented perpendicular to the straight sides 228 and curving inwardly toward the center of the media pack 204. In other embodiments, the shape of the first frame 206 and/or second frame 210 may be different (e.g., an outer perimeter of both the first frame 206 and the second frame 210 may be formed in a racetrack shape or another suitable shape, a first shape of the outer perimeter of the first frame 206 may be the same as described with reference to FIG. 3 and a second shape of the outer perimeter of the second frame 210 may have a substantially rectangular shape that is different from the first shape, etc.).

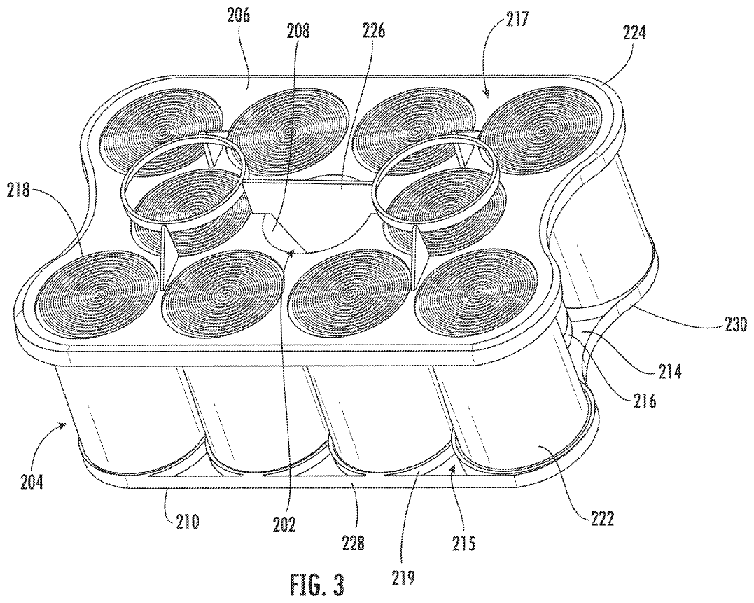

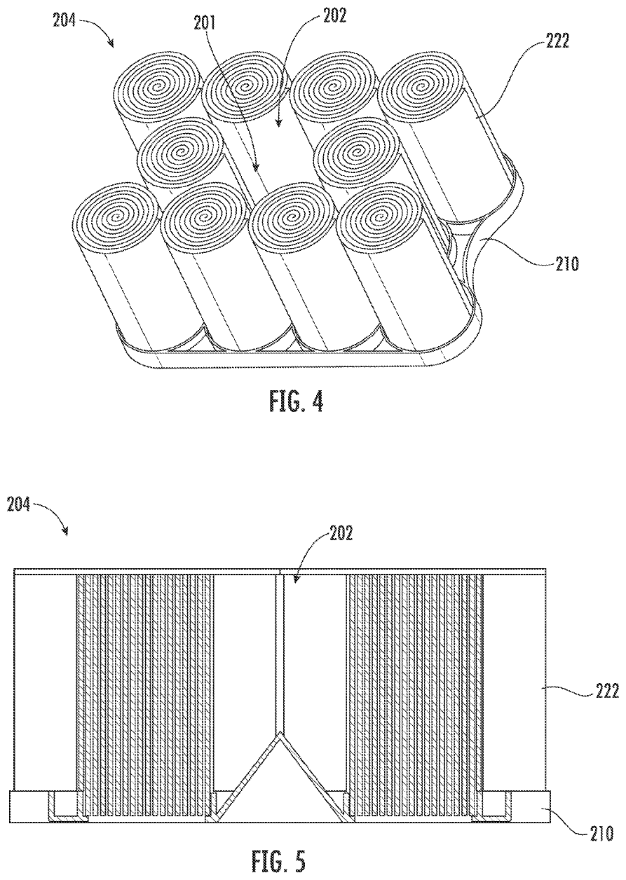

Referring now to FIGS. 4 and 5, a perspective view and a cross-sectional view, respectively, of the media pack 204 of the filter element 200 is shown, according to an example embodiment. The media pack 204 may include a plurality of media modules 222 that are formed separately from one another. The axial ends of each media module are coupled to one of the first frame 206 and the second frame 210, in a respective one of the plurality of receptacles 216. At least one axial end of each media module 222 is sealingly engaged with one of the first frame 206 and the second frame 210 to prevent bypass between the clean and dirty sides of each media module 222 and the media pack 204. In the embodiment of FIGS. 4-5, a downstream end of each media module 222 is potted into a respective one of the plurality of receptacles 216, along an outer perimeter of the media module 222, using urethane or another suitable adhesive. The media modules 222 extend axially away from the base 214 of each frame member such that a central axis of each media module 222 is arranged in a substantially perpendicular orientation with respect to the base 214.

As shown in FIG. 4, the plurality of media modules 222 may be arranged in an array in three parallel rows. The media pack 204 may also include a blank 201 at a central position along the media pack 204. The blank 201 may be a region that is sized to accommodate at least one of the media modules 222 therein but is instead left empty. The blank 201 may form at least part of the keyway 202 for the filter element 200. The keyway 202 may be sized to accommodate a space (e.g., area, volume, etc.) in the media pack 204 that is sized large enough to receive one of the plurality of media modules 222. For example, a cross-sectional size of the keyway (e.g., perpendicular to the flow direction) may be at least as large as a cross-sectional size of at least one of the plurality of media modules 222. The position of the blank media module may be different in various embodiments.

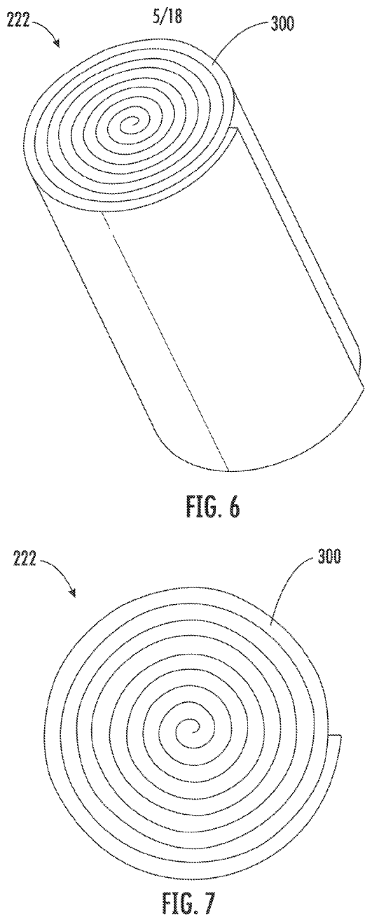

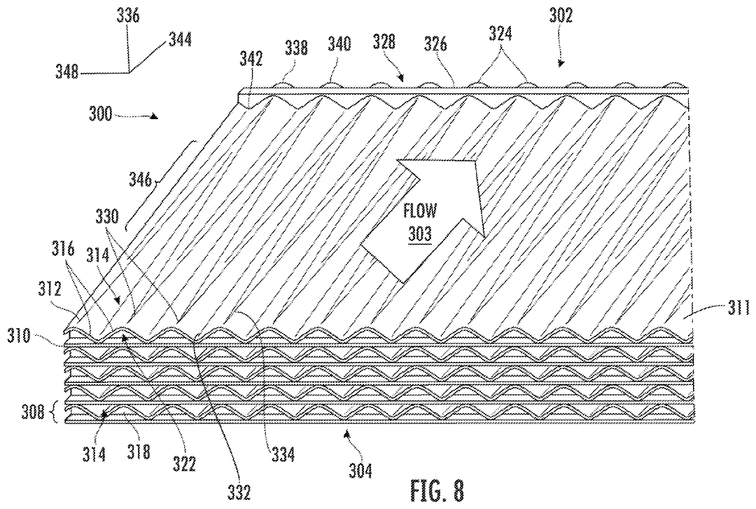

Referring to FIGS. 6 and 7, a perspective view and a top view, respectively, of an individual one of the plurality of media modules 222 is shown, according to an example embodiment. The media module 222 includes a layered stack of filter media that is spirally wound and/or coiled into a first shape, such as a cylindrical shape (e.g., a cylindrical module), which may be arranged together with other media modules along the frame to form a second shape that is different from the first shape. FIG. 8 shows a perspective views of a portion of an unwound (e.g., uncoiled) media module, shown as combined media form 300, according to an example embodiment. The combined media form 300 may include multiple sheets of filter media that are stacked on top of one another.

As shown in FIG. 8, the combined media form 300 includes a flat sheet 310 (e.g., an unformed sheet, a sheet without bend lines, first filtration sheet, etc.) and a formed sheet 308 (e.g., bent sheet, second filtration sheet, etc.) having a different geometry from the flat sheet 310. The formed sheet 308 is coupled to the flat sheet 310 along axial ends of the flat sheet 310. In particular, the layers of flat sheets and formed sheets are alternatively sealed at opposing axial ends of the combined media form 300.

The formed sheet 308 and the flat sheet 310 may both include a filter media 311 including a porous material having a mean pore size that is configured to filter particulate matter from a fluid flowing therethrough so as to produce a filtered fluid. The formed sheet 308 and the flat sheet 310 may include any suitable fibrous filter media, membrane filter media, and/or composite filter media with particle removal and restriction characteristics appropriate to the application.

In at least one embodiment, the formed sheet 308 is pleated (e.g., doubled back on itself), folded, or otherwise formed into a “U” shape or a “V” shape defining forms or channels having a substantially triangular cross-sectional shape that extend along an axial direction between opposing ends of the combined media form 300. In other embodiments, the formed sheet 308 may be formed into another suitable shape. For example, the formed sheet 308 may be pleated, folded, or otherwise formed into a continuous sine wave shape, a sawtooth shape, or another suitable shape. Similarly, the cross-sectional shape of the channels defined by the formed sheet 308 may differ in various embodiments. For example, the formed sheet 308 and the flat sheet 310 may define channels having an elliptical cross-sectional shape, a rectangular cross-sectional shape, or another suitable shape. Depending on the cross-sectional geometry of the channels, the combined media form 300 may include elliptical channels, rectangular channels, or another suitable shape. As described above, in some embodiments the shape of the channels varies in a flow direction 303 (e.g., axially) along the combined media form 300 such that the channels having a non-uniform geometry along the flow direction 303 (e.g., axial direction, parallel to the central axis, etc.) through the combined media form 300. For example, the formed sheet 308 may be bent or otherwise formed such that size of the channels varies along the flow direction 303 through the combined media form 300. As shown in FIG. 8, the formed sheet 308 is defined by a plurality of interdigitated tetrahedral forms extending from the opposing ends of the combined media form 300. Among other benefits, using a tetrahedral media geometry for the formed sheet 308 allows cross-flow between adjacent layers of the combined media form 300 (e.g., in a direction that is substantially perpendicular to the flow direction 303 through the combined media form 300), which can increase dust holding capacity of the filter element 200 as compared to other media geometries.

As shown in FIG. 8, the wall segments may include a first set of wall segments 316 alternately sealed to each other at the upstream end 304, for example, by adhesive 318 or the like, to define a first set of forms 314 (e.g., tetrahedron forms, etc.) having open upstream ends, and a second set of forms 322 interdigitated with the first set of forms 314 and having closed upstream ends. The wall segments may also include a second set of wall segments 324 alternately sealed to each other at the downstream end 302, for example, by adhesive 326 or the like, to define a third set of forms 328 having closed downstream ends, and a fourth set of forms (not shown—similar in geometry to the second set of forms 322) interdigitated with the third set of forms 328 and having closed downstream ends. A first set of bend lines 330 includes a first subset of bend lines 332 defining the first set of forms 314, and a second subset of bend lines 334 defining the second set of forms 322. The second subset of bend lines 334 taper in transverse direction 336 as they extend from the upstream end 304 axially towards the downstream end 302. A second set of bend lines 338 includes a third subset of bend lines 340 defining the third set of forms 328, and a fourth subset of bend lines 342 defining the fourth set of forms. The third subset of bend lines 340 taper in the transverse direction 336 as they extend from the upstream end 304 axially towards the downstream end 302. The second set of forms 322 have a decreasing transverse height along transverse direction 336 as the second set of forms 322 extend axially along axial direction 344 towards the downstream end 302. The tapering of the second subset of bend lines 334 in the transverse direction 336 provides the decreasing transverse height of the second set of forms 322. The third set of forms 328 have a decreasing transverse height along transverse direction 336 as the third set of forms 328 extend axially along axial direction 344 towards the upstream end 304. The tapering of the third subset of bend lines 340 in the transverse direction 336 provides the decreasing transverse height of the third set of forms 328.

Incoming dirty fluid to be filtered flows along axial direction 344 into open ones of the first set of forms 314 at the upstream end 304 and passes transversely through the flat sheets and then flows axially along axial direction 344 as clean filtered fluid through open forms (e.g., the fourth set of forms) at the downstream end 302. In some embodiments, the flow is reversed through the combined media form 300 such that incoming dirty fluid to be filtered flows along axial direction 344 into open forms (e.g., the fourth set of forms) and passes transversely through the flat sheets and then flows axially along axial direction 344 as clean filtered fluid through open ones of the first set of forms 314.

The second subset of bend lines 334 taper to respective termination points, providing at such termination points the minimum transverse height of the second set of forms 322. The third subset of bend lines 340 taper to respective termination points providing at such termination points the minimum transverse height of the third set of forms 328. Termination points of the second subset of bend lines 334 are axially downstream of termination points of third subset of bend lines 340. This arrangement provides a common volume 346 within which flow can distribute in multiple directions between opposing ends of the combined media form 300.

The first set of wall segments 316 are alternately sealed to each other by adhesive 318 at the upstream end 304 to define a first set of forms 314 having open upstream ends, and a second set of forms 322 interdigitated with the first set of forms 314 and having closed upstream ends. The second set of wall segments 324 are alternately sealed to each other by adhesive 326 at the downstream end 302 to define a third set of forms 328 having closed downstream ends, and a fourth set of forms interdigitated with the third set of forms 328 and having open downstream ends.

The first set of forms 314 and the second set of forms 322 face oppositely to the third set of forms 328 and the fourth set of forms. Each of the forms is elongated in the axial direction 344. Each of the forms has a cross-sectional area along a cross-sectional plane defined by the transverse direction 336 and the lateral direction 348. The cross-sectional areas of the first set of forms 314 and the second set of forms 322 decrease as the first set of forms 314 and the second set of forms 322 extend along axial direction 344 from the upstream end 304 toward the downstream end 302. The cross-sectional areas of third set of forms 328 and the fourth set of forms decrease as the third set of forms and the fourth set of forms 328 extend along axial direction 344 from the downstream end 302 toward the upstream end 304. The bend lines in the support sheet 312 may be bent at a sharp pointed angle or rounded along a given radius, as shown in FIG. 8. In other embodiments, another suitable geometry may be formed into the support sheet 312. The flat sheet 310 and the formed sheet 308 may be made from the same or different materials.

As shown in FIG. 8, a single layer of the combined media form 300 (e.g., including the combination of a single flat sheet 310 and a single formed sheet 308) may be stacked repeatedly to produce a media module 222. In other embodiments, as shown in FIGS. 6-7, a single layer of the combined media form 300 may be arranged to produce a media module 222 having a curved cross-sectional shape (having a curved outer perimeter when viewed along a cross-section that is perpendicular to a flow direction through the combined media form 300). For example, a cylindrical media module may be formed by winding, rolling, and/or wrapping a single layer of the combined media form 300 in a spiral (e.g., about a central mandrel, etc.). It will be appreciated that a wide variety of first shapes may be produced from the layered combined media form geometry of FIG. 8 (e.g., a cylindrical media module, an elliptical media module, etc.).

The media modules may be produced in a first shape and may be arranged together to form any desired second shape for the combined media pack. Referring to FIGS. 9-11, perspective views of different media pack arrangements are shown, according to various example embodiments. For example, FIG. 9 shows a media pack 404 including a plurality of media modules 422 arranged in parallel rows in a substantially rectangular-shaped array, but having depressions 423 (e.g., recessed areas, etc.) on opposing lateral ends of the media pack 404 that are sized to receive a media module therein. The depressions 423 result from using a reduced number of media modules along a central row of the array (e.g., three modules in the center row and four media modules in the outer rows), and allow the media pack 404 to fit within a space having a non-rectangular cross-section.

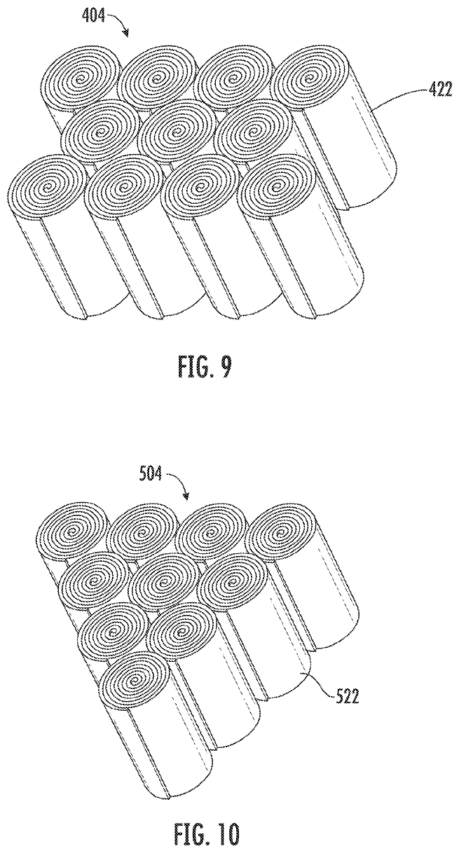

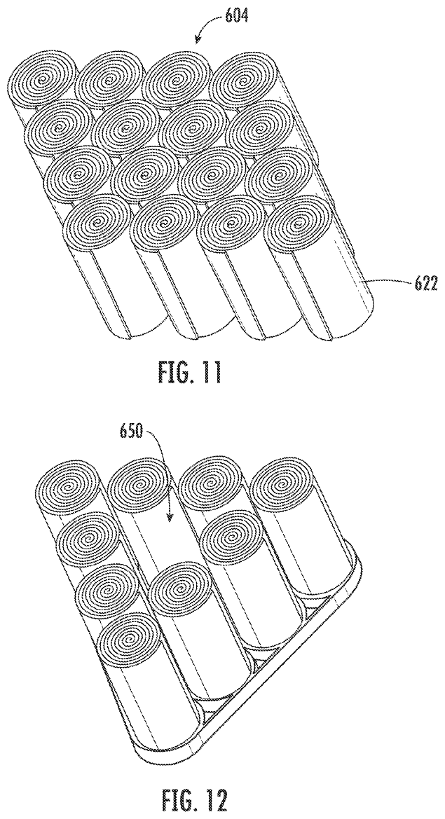

FIG. 10 shows a media pack 504 including a plurality of media modules 522 arranged in parallel rows to form a substantially triangular-shaped array, and FIG. 11 shows a media pack 604 including a plurality of media modules 622 arranged in parallel rows to form a substantially trapezoidal-shaped array. As shown in each of FIGS. 9-11, adjacent rows of the media modules are offset from one another (e.g., staggered) to ensure uniform spacing between each media module and to reduce restriction across the media pack.

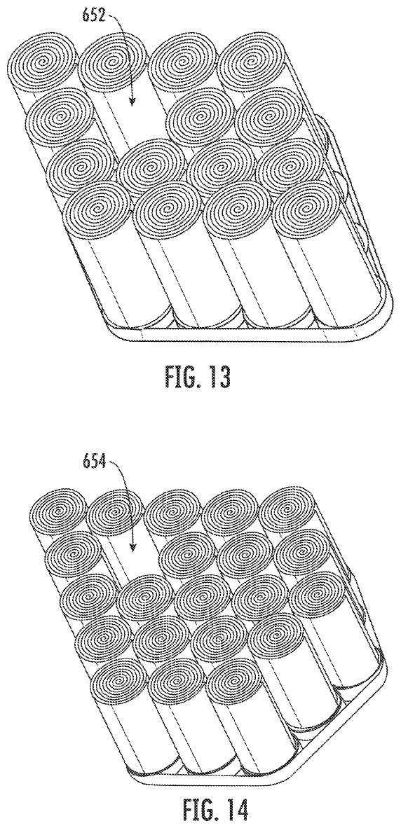

Referring to FIGS. 12-14, the media packs may include a blank 650, 652, 654 (e.g., an unused area disposed at a central position along the media pack that is surrounded on all sides by other media modules). The blank may at least partially form a keyway for the media pack. The keyway may facilitate alignment between the media pack and the housing. The position of the keyway may be modified for different client applications to prevent the use of non-genuine filter elements, by leaving a space in place of a different one of the plurality of media modules. Positioning the blank at a central position may also improve flow distribution between the media modules of the media pack. The design of the position of the keyway opening or frame wall may also be different in various embodiments.

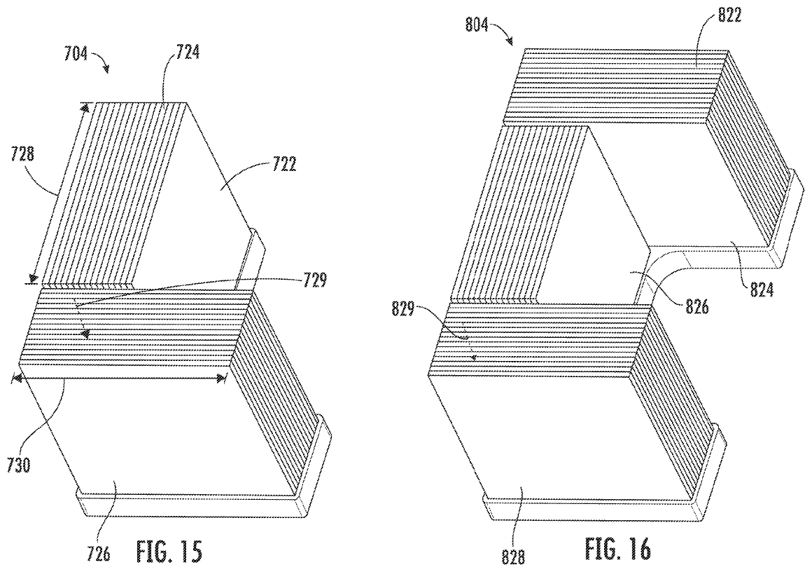

As described above, the media modules may be produced in a wide variety of first shapes, and are not limited to a cylindrical shape as shown in FIOS. 9-14. For example, FIGS. 15-16 show media packs that each include media modules having a substantially rectangular shape. For example. FIG. 15 shows a media pack 704 that includes two separate media modules 722, where each media module is formed in the shape of a right rectangular prism. A first media module 724 of the media pack 704 extends away from an outer side of a second media module 726 in a substantially perpendicular orientation relative to the second media module 726. Together, the arrangement of media modules 722 forms an “L” shaped media pack 704. The shape of a frame 706 of the filter element matches an overall shape formed by the media modules 722. Note that in some embodiments a size of at least one of the media modules may be different from a size of the remaining media modules. For example, FIG. 15 shows that the first media module 724 may have a first width 728, perpendicular to the flow direction 729 that is greater than a second width 730 of the second media module 726.

FIG. 16 shows a media pack 804 that is similar to the media pack 704 of FIG. 15, but that further includes a third media module 828 disposed on an opposite end of the first media module 824 as the second media module 826. Together, the media modules 822 form a media pack 804 that forms a “U” shape when viewed along a cross-section that is perpendicular to a flow direction 829 through the media pack 804.

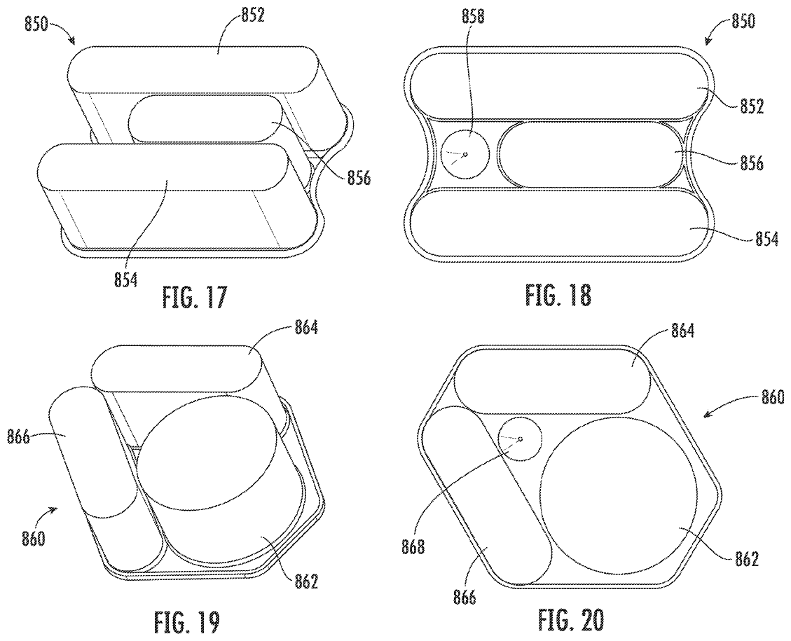

FIGS. 17-18 show an example embodiment of a media pack 850 having a similar shape as the media pack shown in FIG. 9 using a fewer number of media modules. For example, the media pack 850 includes three oblong-shaped media packs (e.g., pill shaped media packs having two parallel edges connected at opposing ends by curved edges of approximately equal radius), shown as a first media module 852, a second media module 854, and a third media module 856. Each media pack accommodates a space equal to that of an individual row from the media pack shown in FIG. 9. The first media module 852 is approximately equal in size to the second media module 854. The third media module 856 is smaller along a transverse direction (e.g., perpendicular to a flow direction through the media pack) than both the first media module 852 and the second media module 854. The third media module 856 is sandwiched or otherwise disposed between the first media module 852 and the second media module 854 and is offset relative to the first media module 852 and the second media module 854 to form a keyway 858 for the filter element.

The media modules may be formed by winding or coiling a combined media form around a core element. For example, the media modules may be formed by winding a combined media form around a cylindrical mandrel, or around a plate to form oblong media modules. An aspect ratio of the oblong media modules (e.g., a length dimension relative to a width dimension) may be varied based on the length of the core element. It should be appreciated that the media pack can be formed from a single combined media form by winding and cutting the combined media form repeatedly to form each individual media module. Beneficially, using two to three larger sized media modules to form a media pack shape (as shown in FIGS. 17-18) instead of arrays of four or more media modules reduces the number of starting and stopping operations performed by the winding system in order to build the media pack (e.g., reduces the number of individual winding operations needed to coll and/or form all of the media modules for the media pack). This can also increase overall flow area through the media pack by reducing the number of areas with a higher risk of collapse during the forming process, such as at the leading and trailing edges of the combined media form in each winding.

It should be appreciated that the height of the media modules may also vary across the filter element. For example, the third media module 856 from FIGS. 17-18 could have a reduced axial height and/or depth relative to the first media module 852 and the second media module 854, along a flow direction through the third media module 856, and could provide another region of the filter element into which the housing could extend (e.g., an interior wall of the housing, etc.). Beneficially, such an implementation may provide greater media or flow face area for a given packaging space while still providing an indent or keyed feature to prevent the use of non-genuine filter element designs. Such a design may be implemented on any of the other embodiments described herein to allow for different packaging configurations in different applications, which may better accommodate the space constraints allowed for the housing without significantly altering the performance of the filter element.

FIGS. 19-20 show an example embodiment of a media pack 860 that includes media modules of multiple different shapes. The media pack 860 includes a single cylindrically-shaped media module, shown as first media module 862, and a plurality of oblong-shaped media packs, shown as second media module 864 and third media module 866. In the embodiment of FIGS. 19-20, the second media module 864 and the third media module 866 are approximately the same size. In other embodiments, the relative size of the second media module 864 and the third media module 866 may be different. The second media module 864 and the third media module 866 are positioned adjacent to one another at their first sides and extend away from one another at an angle. The angle may be sized so that the second media module 864 and the third media module 866 at least partially surround the first media module 862 and are adjacent to the first media module 862 at their second end. Together, the first media module 862, the second media module 864, and the third media module 866 may define a triangular-shaped cavity or keyway 868 for the filter element.

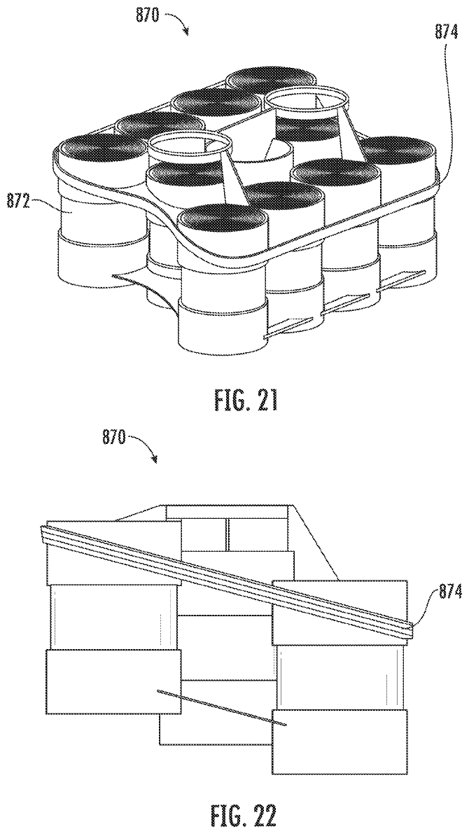

FIGS. 21-22 show an example embodiment of a filter element 870 having a staggered arrangement of media modules. As shown in FIG. 21, the media modules 872 are arranged in three substantially linear rows. As shown in FIG. 22, the media modules 872 within each row are staggered or axially offset from the media modules in the adjacent row(s). The frames of the filter element 870 each includes a plurality of receptacles that are arranged in a similar manner as the media modules 872. At least one frame member includes a seal member 874 that is oriented at an angle to match the angle caused by the offset arrangement of the media modules 872. In other embodiments, the seal member may be aligned with a horizontal reference plane that is oriented perpendicular to a central axis of the media modules. It should be appreciated that different axial offsets between the media modules 872 in each row allows the option to provide different angles and can be tailored to accommodate different applications. The axial offset between the media modules 872 in adjacent rows may also vary across the width or length of the media pack (e.g., between columns and rows or in different amounts along a single row, etc.). In some embodiments, an axial height of at least one media module 872 of the filter element 870 may be different from the other media modules so as to accommodate different packaging constraints for different applications.

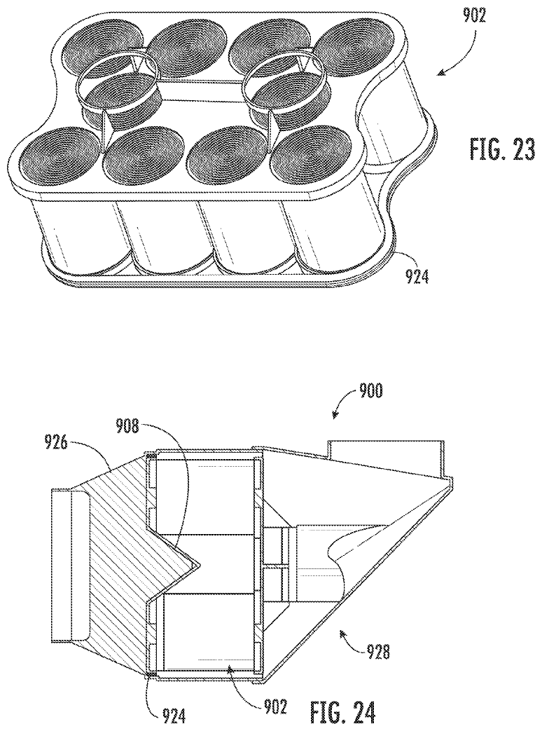

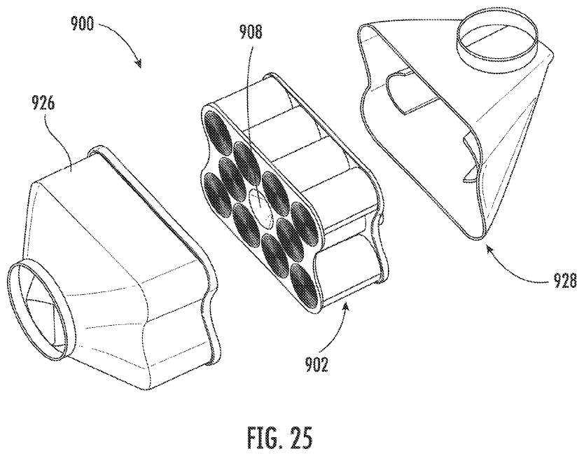

The arrangement and geometry of the media packs described with reference to FIGS. 1-22 should not be considered limiting. Many variations are possible without departing from the inventive concepts disclosed herein. In particular, the arrangement of the sealing member, frame members, and keyway may be different in various embodiments. For example. FIGS. 23-25 show a filter assembly 900 including a filter element 902 in which the keyway and sealing member are arranged on an opposing end of the filter element 902 as compared to the embodiment in FIGS. 1-3. In particular, both the sealing member 924 and the frame wall 908 (e.g., second conical projection) are disposed on a second end (e.g., downstream end, etc.) of the filter element 902. The sealing member 924 engages a radially-facing sealing surface that is disposed approximately half-way between opposing ends of the second portion 926 (e.g., outlet portion) of the housing 928. Among other benefits, positioning the sealing member on the second end of the filter element 902 may improve the integrity of the seal between the housing 928 and the filter element 902.

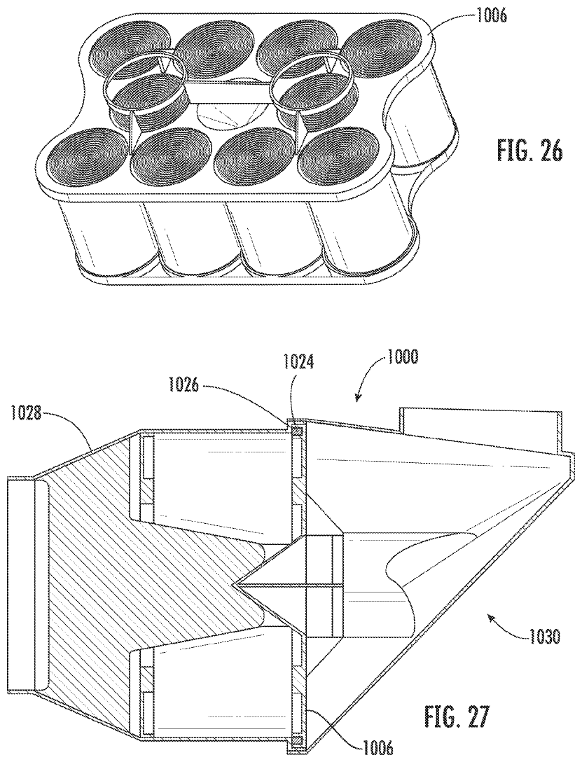

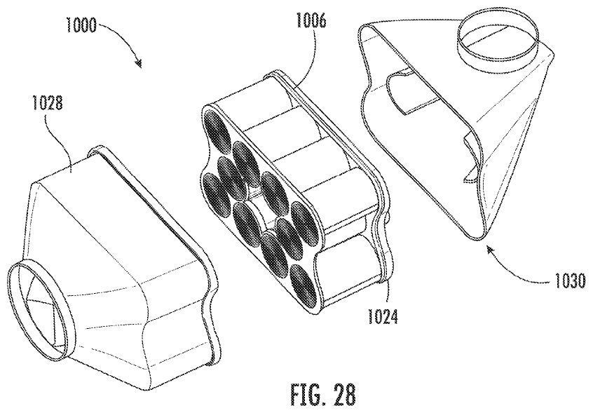

FIGS. 26-28 show another embodiment of a filter assembly 1000. Unlike the embodiment shown in FIGS. 1-3, the filter assembly 1000 in FIGS. 26-28 includes a first sealing member 1024 that faces axially away from the first frame member, shown as first frame 1006, such that the first sealing member 1024 is configured to sealingly engage with an axially-facing surface 1026 of the second portion 1028 of the housing 1030. The filter assembly 1000 may also include a second sealing member (or a second portion of the first sealing member) that faces radially away from the first frame member such that the second sealing member is configured to sealingly engage with a radially-facing surface of the second portion of the housing. In other words, the filter assembly 1000 may include both an axial sealing member and a radial sealing member to improve the integrity of the seal between the filter element and the housing.

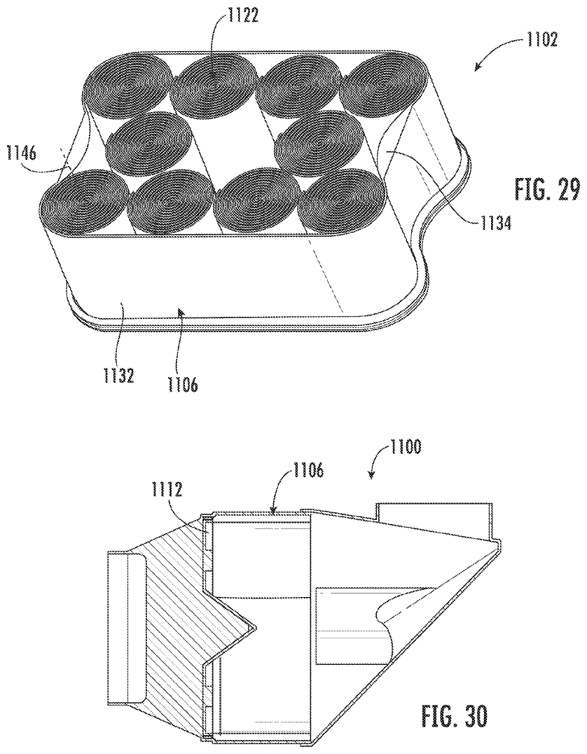

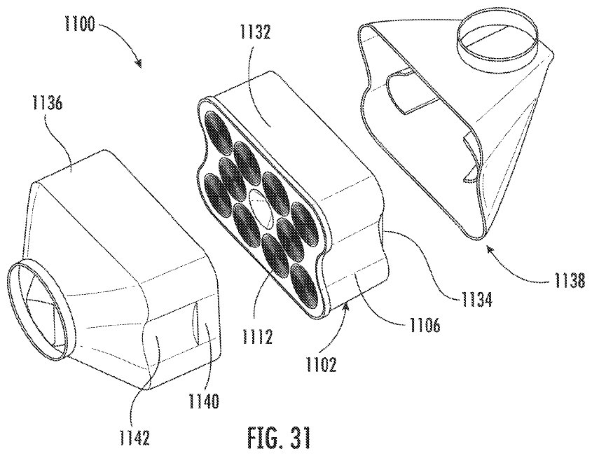

FIGS. 29-31 show yet another embodiment of a filter assembly 1100 and filter element 1102. The filter element 1102 includes a bucket-style frame, shown as frame 1106, having a base 1112 and a side wall 1132 that extends axially away from the base 1112 in a substantially perpendicular orientation relative to the base 1112. The side wall 1132 extends along an outer perimeter of the base 1112 and circumscribes (e.g., surrounds) the plurality of receptacles and the plurality of media modules 1122. The frame 1106 further includes handles 1134 disposed on opposing lateral ends of the filter element 1102 at an outer (e.g., free) end of the side wall 1132. As shown in FIG. 31, the second portion 1136 of the housing 1138 may have a shape that is complementary to the shape of the frame 1106. For example, the second portion 1136 may have a first cross-sectional shape 1140 (e.g., a rectangular cross-sectional shape) sized to receive a handle portion of the frame 1106 and a second cross-sectional shape 1142 (e.g., a non-rectangular cross-sectional shape) axially offset from the first cross-sectional shape 1140 and sized to receive the portion of the frame 1106 away from the handles 1134. Among other benefits, the bucket-style frame design may facilitate manipulation of the multi-module filter element and may improve the overall structure integrity of the filter element 1102.

As shown in FIG. 29, the filter element 1102 includes a seal member 1144 disposed at an axial end of the frame 1106 and extending along an outer perimeter of the frame 1106. The seal member 1144 may extend along a plane that is substantially perpendicular to a central axis 1146 of the media modules. However, it should be appreciated that the position and/or orientation of the seal member may be different in other embodiments. For example, the seal member may be disposed at a mid-plane of the frame 1106 between opposing axial ends of the frame 1106. In other embodiments, the seal member may be angled with respect to the central axis of the media modules (see, for example, FIG. 22), which can, beneficially, facilitate assembly of the filter element into the filter housing in different applications and/or accommodate different packaging constraints in different applications. It should be appreciated that the angle of the seal member for any of the embodiments disclosed herein may vary to accommodate different packaging constraints or arrangements.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein, Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter element, comprising:
a frame, comprising:
a base;
a plurality of receptacles extending across the base; and
a keyway disposed in between two receptacles of the plurality of receptacles, the keyway structured to facilitate alignment between the filter element and a filter housing; and
a media pack coupled to the frame, the media pack comprising a plurality of media modules each coupled to a respective one of the plurality of receptacles.

2. The filter element of claim 1, wherein the plurality of receptacles extend in at least one row across the base, the keyway disposed along the at least one row.

3. The filter element of claim 1, wherein a cross-sectional size of the keyway is at least as large as a cross-sectional size of at least one of the plurality of media modules.

4. The filter element of claim 1, wherein a size of a first media module of the plurality of media modules differs from a size of a second media module of the plurality of media modules.

5. The filter element of claim 1, wherein the frame comprises a side wall extending away from the base in a substantially perpendicular orientation relative to the base, the side wall circumscribing the plurality of media modules.

6. The filter element of claim 1, wherein an outer perimeter of the frame has both a non-circular and non-rectangular cross-sectional shape.

7. The filter element of claim 1, wherein the keyway comprises a keyway opening that extends through the base.

8. The filter element of claim 1, wherein the keyway comprises a frame wall that extends axially away from the base.

9. The filter element of claim 8, wherein the frame wall comprises a conical protrusion.

10. The filter element of claim 1, wherein each media module of the plurality of media modules includes a flat sheet and a formed sheet coupled to the flat sheet, the formed sheet comprising an upstream end, a downstream end, and a plurality of bend lines, the plurality of bend lines extending axially along an axial direction and comprising a first set of bend lines extending from the upstream end axially towards the downstream end, and a second set of bend lines extending from the downstream end axially towards the upstream end, the formed sheet having a plurality of wall segments extending axially and defining forms therebetween, the forms having a height along a transverse direction, perpendicular to the axial direction, that tapers along the axial direction.

11. The filter element of claim 1, wherein each media module of the plurality of media modules includes a flat sheet and a formed sheet coupled to the flat sheet, the flat sheet and the formed sheet for a first media module of the plurality of media modules wound together in a substantially spiral shape, the first media module extending away from the frame in a substantially perpendicular orientation relative to the frame.

12. The filter element of claim 1, wherein each media module of the plurality of media modules includes a flat sheet and a formed sheet coupled to the flat sheet, the flat sheet and the formed sheet arranged as substantially planar sheets that are layered on top of one another in an alternating fashion.

13. A filter assembly, comprising:
a housing defining an interior cavity and comprising an interior wall extending into the interior cavity; and
a filter element disposed at least partially within the interior cavity, the filter element comprising:
a media pack comprising a plurality of media modules; and
a frame coupled to the media pack, the frame comprising a keyway disposed in between two media modules of the plurality of media modules, the interior wall extending into the keyway.

14. The filter assembly of claim 13, wherein a cross-sectional size of the keyway is at least as large as a cross-sectional size of at least one of the plurality of media modules.

15. The filter assembly of claim 13, wherein a sealing interface between the filter element and the housing has a non-circular and non-rectangular shape.

16. The filter assembly of claim 13, wherein the frame is oriented substantially normal to an airflow direction through the housing.

17. The filter assembly of claim 13, wherein the interior wall defines a recessed area at an outer end thereof, the keyway comprising a first wall that extends parallel to the plurality of media modules and into the recessed area.

18. The filter assembly of claim 13, wherein an inlet and an outlet of the filter element are both located along the same plane.

19. The filter assembly of claim 13, wherein each media module of the plurality of media modules includes a flat sheet and a formed sheet coupled to the flat sheet, the formed sheet comprising an upstream end, a downstream end, and a plurality of bend lines, the plurality of bend lines extending axially along an axial direction and comprising a first set of bend lines extending from the upstream end axially towards the downstream end, and a second set of bend lines extending from the downstream end axially towards the upstream end, the formed sheet having a plurality of wall segments extending axially and defining forms therebetween, the forms having a height along a transverse direction, perpendicular to the axial direction, that tapers along the axial direction.

20. A frame for a filter element, comprising:
a base;
a plurality of receptacles extending across the base, each receptacle of the plurality of receptacles sized to receive a media module therein, each receptacle of the plurality of receptacles defining an opening that extends through the base; and
a keyway disposed adjacent to at least one of the plurality of receptacles, the keyway configured to engage an interior wall of a filter housing to facilitate alignment between the filter element and the filter housing, the keyway comprising a first wall that extends axially away from the base.

21. The frame of claim 20, further comprising a side wall that extends axially away from the base along an outer perimeter of the base, the side wall circumscribing the plurality of receptacles.

22. The frame of claim 20, further comprising a handle disposed at the keyway and extending axially away from the base.

23. The frame of claim 20, wherein an outer perimeter of the base has a non-circular and non-rectangular cross-sectional shape.
